(19) United States
(12) Patent Application Publication
(10) Pub. No.: US 2014/0029249 A1
(43) Pub. Date: Jan. 30, 2014

(54) LIGHTING DEVICE

(71) Applicant: Funai Electric Co., Ltd., Osaka (JP)

(72) Inventor: Chiharu MATSUKAWA, Osaka (JP)

(21) Appl. No.: 13/945,006

(22) Filed: Jul. 18, 2013

(30) Foreign Application Priority Data
Jul. 30, 2012 (JP) 2012-168852

(51) Int. Cl. F21V 29/00

(52) U.S. Cl. CPC F21V 29/22
USPC 362/218

(57) ABSTRACT

A lighting device includes a tube, a light emitting element, a heat sink and a wiring. The light emitting element is disposed inside the tube. The heat sink is disposed inside the tube. The heat sink includes a concave wire housing in an outer face of the heat sink that is opposite an inner face of the tube. The heat sink is configured to dissipate heat generated from the light emitting element. The wiring is disposed in the concave wire housing such that the wiring extends from one end of the tube to the other end of the tube in a lengthwise direction of the tube.

### CROSS-REFERENCE TO RELATED APPLICATIONS

This application claims priority to Japanese Patent Application No. 2012-168852 filed on Jul. 30, 2012. The entire disclosure of Japanese Patent Application No. 2012-168852 is hereby incorporated herein by reference.

### BACKGROUND

1. Field of the Invention

The present invention generally relates to a lighting device. More specifically, the present invention relates to a lighting device with a light emitting element.

2. Background Information

Lighting devices with a light emitting element are well-known in the past (see Japanese Utility Model Registration No. 3,167,230 (Patent Literature 1), for example).

The above-mentioned Patent Literature 1 discloses a straight-tube fluorescent LED device (lighting device) including an LED element (light emitting element), an aluminum heat dissipating tube (heat sink) that dissipates heat generated by the LED element, and a polycarbonate cover that covers the LED element. With this straight-tube fluorescent LED device, the aluminum heat dissipating tube is exposed on the outside, and a gap is provided in which a power supply cable (wiring) can be housed.

### SUMMARY

It has been discovered that with the straight-tube fluorescent LED device (lighting device) in Patent Literature 1, when the power supply cable (wiring) is housed in the gap of the aluminum heat dissipating tube, the power supply cable is exposed on the outside since the aluminum heat dissipating tube is exposed on the outside. Thus, it has been discovered that with this straight-tube fluorescent LED device, the power supply cable is susceptible to damage.

One object of the present disclosure is to provide a lighting device with which wiring damage can be reduced.

In view of the state of the know technology, a lighting device includes a tube, a light emitting element, a heat sink and a wiring. The light emitting element is disposed inside the tube. The heat sink is disposed inside the tube. The heat sink includes a concave wire housing in an outer face of the heat sink that is opposite an inner face of the tube. The heat sink is configured to dissipate heat generated from the light emitting element. The wiring is disposed in the concave wire housing such that the wiring extends from one end of the tube to the other end of the tube in a lengthwise direction of the tube.

Other objects, features, aspects and advantages of the present disclosure will become apparent to those skilled in the art from the following detailed description, which, taken in conjunction with the annexed drawings, discloses a preferred embodiment of the lighting device.

### BRIEF DESCRIPTION OF THE DRAWINGS

Referring now to the attached drawings which form a part of this original disclosure:

FIG. 1 is a perspective view of a straight-tube LED lighting device in accordance with one embodiment;

FIG. 2 is an exploded perspective view of the straight-tube LED lighting device illustrated in FIG. 1;

FIG. 3 is a plan view of an LED substrate of the straight-tube LED lighting device illustrated in FIG. 1;

FIG. 4 is a cross sectional view of the LED substrate of the straight-tube LED lighting device illustrated in FIG. 1, taken along 200-200 line in FIG. 1;

FIG. 5 is an enlarged, partial cross sectional view of the straight-tube LED lighting device illustrated in FIG. 1, illustrating a layout of a control board and a power supply board of the straight-tube LED lighting device illustrated in FIG. 1;

FIG. 6 is a simplified diagram of a wiring of the straight-tube LED lighting device illustrated in FIG. 1;

FIG. 7 is a perspective view of a heat sink of the straight-tube LED lighting device illustrated in FIG. 1;

FIG. 8 is a cross sectional view of a modified straight-tube LED lighting device; and

FIG. 9 is a cross sectional view of another modified straight-tube LED lighting device.

### DETAILED DESCRIPTION OF EMBODIMENTS

A preferred embodiment will now be explained with reference to the drawings. It will be apparent to those skilled in the art from this disclosure that the following descriptions of the embodiment are provided for illustration only and not for the purpose of limiting the invention as defined by the appended claims and their equivalents.

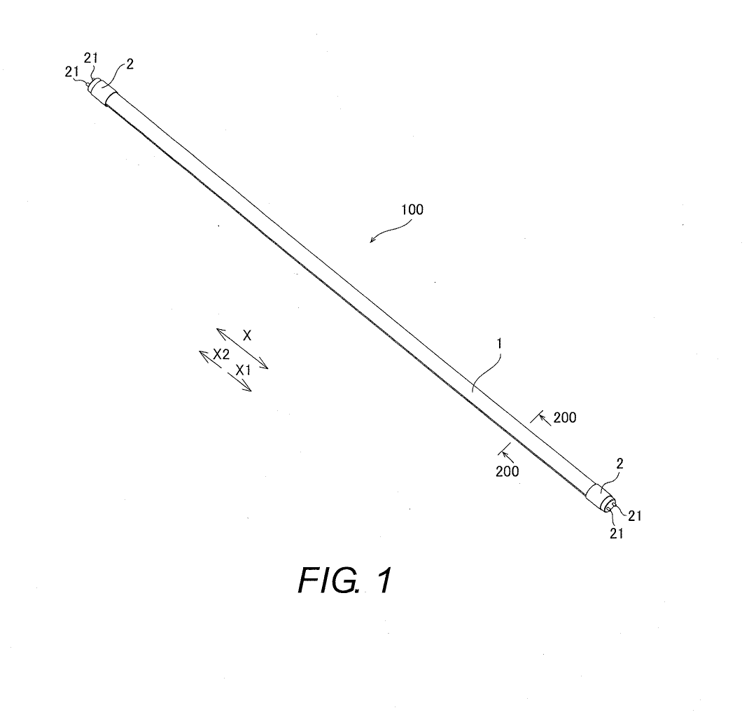

Referring initially to FIGS. 1 to 7, a straight-tube LED lighting device 100 is illustrated in accordance with one embodiment. The straight-tube LED lighting device 100 is an example of the “lighting device” of the present invention.

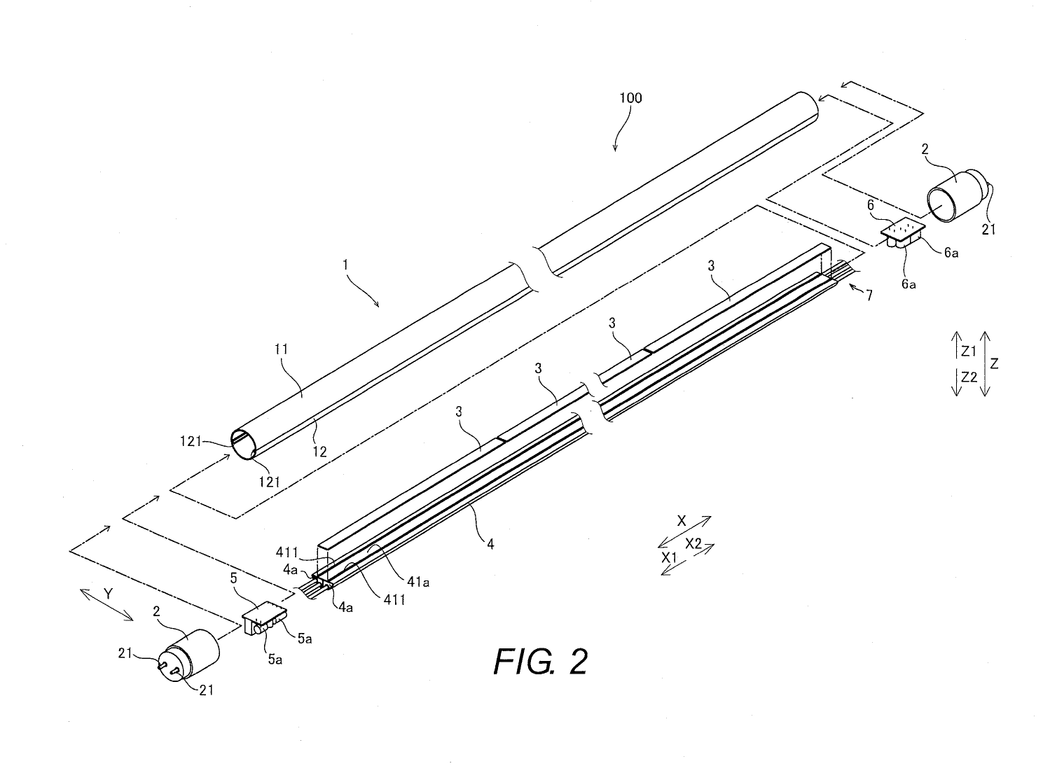

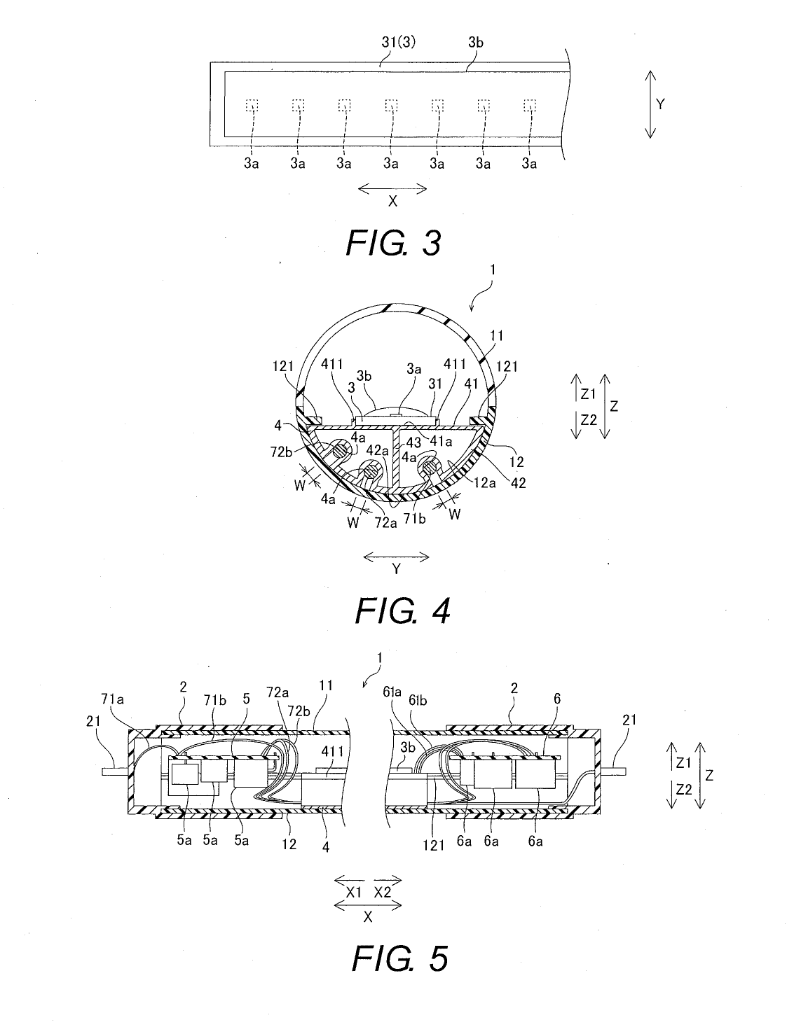

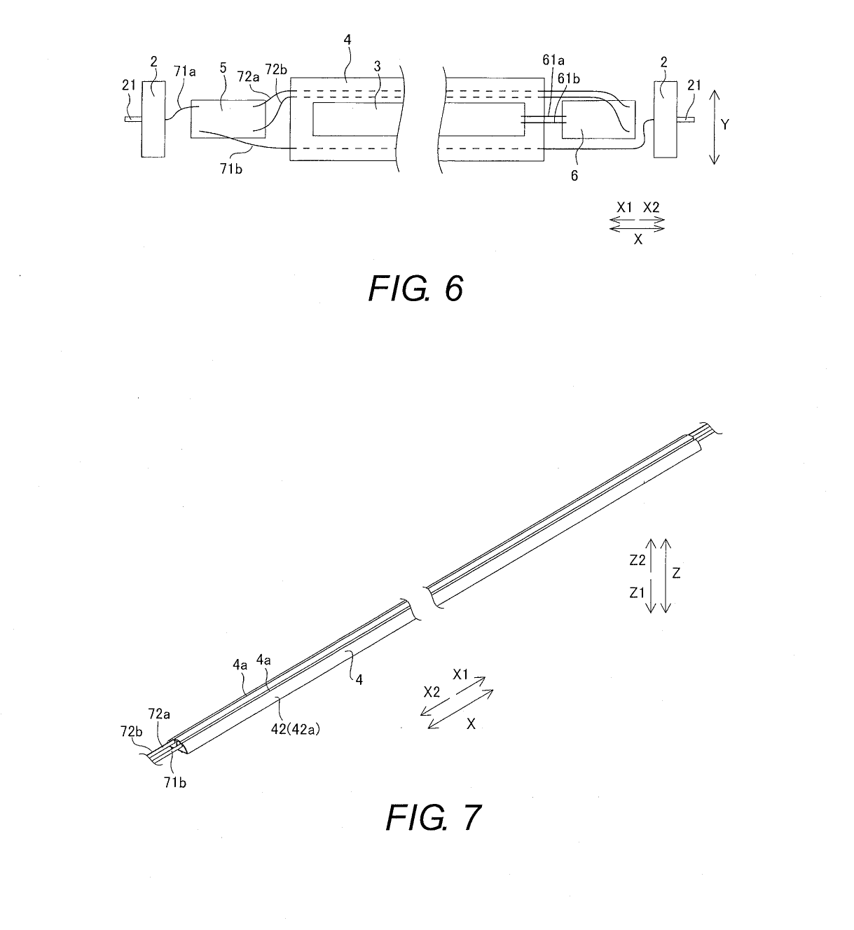

As shown in FIG. 1, the straight-tube LED lighting device 100 in this embodiment includes a tube 1 that extends linearly, and a pair of caps 2 attached to the ends of the tube 1 in its axial direction (the X direction). As shown in FIG. 2, a plurality of LED boards 3, a heat sink 4, a power support board 5, a control board 6 and connector cables 7 (71a, 71b, 72a, and 72b (see FIGS. 5 and 6)) are housed inside the tube 1. As shown in FIG. 3, a plurality of LED (light emitting diode) elements 3a is mounted on the LED boards 3. The heat sink 4 dissipates heat generated by the LED elements 3a and supports the LED boards 3. A plurality of electronic parts 5a is mounted on the power supply board 5. A plurality of electronic parts 6a is mounted on the control board 6. The tube 1 is an example of the “tube” of the present invention. The LED boards 3 are an example of the “element board” of the present invention. The LED elements 3a are an example of the “light emitting element” of the present invention. The connector cables 71b, 72a, and 72b are an example of the “wiring” of the present invention. The power supply board 5 and the control board 6 are examples of the “first board” and the “second board” of the present invention, respectively.

The tube 1 extends linearly and is formed in a cylindrical shape. More specifically, the tube 1 is formed such that its inner face is circular. As shown in FIGS. 2 and 4, the tube 1 includes a front part 11 and a rear part 12. The front part 11 is disposed on the Z1 direction side and has a substantially semicircular arc shape. The rear part 12 is disposed on the Z2 direction side and has a substantially semicircular arc shape. The tube 1 is formed in a cylindrical shape in which the front part 11 and the rear part 12 are integrated. Also, the tube 1 is made of a resin material, such as a polycarbonate. The front part 11 and the rear part 12 are integrally molded, respectively. The front part 11 includes a light diffusing material. The front part 11 is configured such that light emitted from the LED elements 3a is diffused while still being transmitted. The rear part 12 includes a light diffusing material. The rear part 12 is configured such that it does not transmit light as readily as the front part 11 does. The front part 11 is semi-transparent, and the rear part 12 is substantially opaque. The front part 11 and the rear part 12 have a thickness of approximately 1 mm.

As shown in FIGS. 2 and 4, a pair of ribs 121 is provided in the interior of the tube 1. The ribs 121 are formed so that they extend in the tube axial direction over the entire tube length from one end to the other in the tube axial direction of the tube 1 (the X direction). Also, the ribs 121 have the function of restricting the movement of the heat sink 4. The ribs 121 also function as guides when the heat sink 4 is being inserted into the tube 1.

As shown in FIGS. 1 and 2, the caps 2 are attached and fixed so as to cover the tube 1 at both ends in the tube axial direction of the tube 1 (the X direction). A pair of terminals 21 is provided to each of the caps 2. The terminals 21 are configured such that power is supplied via the socket terminals (not shown) of a lighting fixture to which the straight-tube LED lighting device 100 is attached. As shown in FIGS. 5 and 6, the terminals 21 are connected to the power supply board 5 via the connector cables 7 (71a and 71b).

As shown in FIG. 2, the LED boards 3 have a rectangular shape in plan view (when viewed in the Z direction). The LED boards 3 are formed so that they extend in the tube axial direction (the X direction). The LED boards 3 are also provided between the power supply board 5 and the control board 6 in the tube axial direction (the X direction). The LED boards 3 are arranged in series in the lengthwise direction of the LED boards 3 (the X direction). The adjacent LED boards 3 are electrically connected to each other by connecting members (not shown). The LED boards 3 are made of a glass-based board with excellent thermal conductivity, such as a glass composite board. The LED boards 3 have a thickness of approximately 1 mm.

As shown in FIGS. 3 and 4, the plurality of LED elements 3a are mounted on light emitting element mounting faces 31 of the LED boards 3. As shown in FIG. 3, the LED elements 3a are arranged in one row, spaced equally apart in the tube axial direction (the X direction). Fluorescent materials 3b are provided to the light emitting element mounting faces 31 of the LED boards 3 so as to cover the LED elements 3a. The fluorescent materials 3b have a dome shape when viewed in the tube axial direction. The fluorescent materials 3b are provided so as to extend in the tube axial direction. The fluorescent materials 3b are configured such that they are excited by light emitted from the LED elements 3a, and emit light of a specific color. The components of the fluorescent materials 3b are adjusted so that the light obtained by mixing light emitted from the fluorescent materials 3b with direct light from the LED elements 3a will have a specific color temperature.

In this embodiment, as shown in FIG. 2, the heat sink 4 is formed so as to extend from one end of the tube 1 (on the X1 direction side) to the other end (on the X2 direction side) in the lengthwise direction (the X direction). More precisely, the heat sink 4 is formed in a length that is shorter than the tube 1 in the tube axial direction. The heat sink 4 is disposed in the approximate center of the tube 1 in the tube axial direction. The heat sink 4 is housed inside the tube 1. More specifically, the heat sink 4 is inserted into the interior of the tube 1 such that it is positioned in the Z direction by the pair of ribs 121 of the tube 1. The heat sink 4 is formed from a metal material with excellent thermal conductivity, such as an aluminum material. Also, the heat sink 4 is formed by extrusion molding. As shown in FIGS. 2 and 4, the heat sink 4 has three concave wire housings 4a provided at a portion of the outer face 42a that is opposite the inner face 12a of the tube 1.

As shown in FIG. 4, the heat sink 4 is formed hollow in the tube axial direction. More specifically, the heat sink 4 includes a flat face part 41 and an arc-shaped part 42. The flat face part 41 is disposed on the Z1 direction side. The arc-shaped part 42 is disposed on the Z2 direction side. The heat sink 4 also includes a reinforcing rib 43. The reinforcing rib 43 links the flat face part 41 and the arc-shaped part 42 to each other. The reinforcing rib 43 is provided in the approximate center of the heat sink 4 in the Y direction. The flat face part 41, the arc-shaped part 42, and the reinforcing rib 43 have a wall thickness of approximately 0.7 mm. Thus forming the heat sink 4 hollow makes the heat sink 4 more lightweight.

As shown in FIG. 2, the flat face part 41 has board placement components 41a on which the LED boards 3 are placed. The flat face part 41 is formed in a flat shape. More precisely, the LED boards 3 are attached to the board placement components 41a with heat dissipating tape (not shown). A pair of ribs 411 is provided to the flat face part 41. The ribs 411 extend all the way in the tube axial direction from one end of the heat sink 4 to the other end in the tube axial direction (the X direction). The pair of ribs 411 is formed integrally with the flat face part 41. The ribs 411 are configured to function as positioning members that restrict the movement of the LED boards 3 in the Y direction.

The arc-shaped part 42 is formed in a shape that conforms to the circular inner face 12a of the tube 1. More specifically, as shown in FIG. 4, the arc-shaped part 42 has an outer face 42a with substantially the same radius of curvature as the inner face 12a of the tube 1, when viewed in the tube axial direction (the X direction). Specifically, the arc-shaped part 42 is formed in an arc shape with substantially the same radius of curvature as the inner face 12a of the tube 1 when viewed in the tube axial direction.

In this embodiment, as shown in FIG. 4, the three wire housings 4a are configured so as to house the connector cables 71b, 72a, and 72b, respectively, which extend from one end of the tube 1 (on the X1 direction side) to the other end (on the X2 direction side) in the lengthwise direction of the tube 1 (the X direction). More specifically, the wire housings 4a are formed along the entire heat sink 4 in the lengthwise direction (the X direction). The wire housings 4a are also formed in a concave shape. More specifically, the wire housings 4a are formed so as to be recessed inward in the outer face 42a of the arc-shaped part 42 of the heat sink 4. Also, the inner faces of the concave wire housing 4a are formed in an arc shape that corresponds to the substantially circular outer peripheral faces of the connector cables 71b, 72a, and 72b. More specifically, the inner faces of the wire housings 4a are formed in an arc shape with substantially the same radius of curvature as the connector cables 71b, 72a, and 72b, which have a substantially circular cross sectional shape.

As shown in FIG. 4, the wire housings 4a are formed such that the width W of the open ends, which are the inlets for the connector cables 71b, 72a, and 72b, is less than or equal to the width of the connector cables 71b, 72a, and 72b. That is, the width W of the open ends extending in the X direction of the wire housings 4a is less than or equal to the diameter of the connector cables 71b, 72a, and 72b. Also, the wire housings 4a fix and house the connector cables 71b, 72a, and 72b at positions that are away from the inner face 12a of the tube 1. More specifically, the wire housings 4a fix and house the connector cables 71b, 72a, and 72b at positions that are located inside with respect to the outer face 42a.

The heat sink 4 is restricted from shifting from a specific layout position in directions (the Y direction and Z direction) that intersect the tube axial direction of the tube 1 (the X direction) by the pair of ribs 121 provided to the tube 1, in a state of being housed in the interior of the tube 1. Specifically, the heat sink 4 is restricted from moving in the Y direction and the Z direction when the arc-shaped part 42 contacts the inner face 12a of the tube 1 and the flat face part 41 contacts the pair of ribs 121.

The power supply board 5 is configured such that AC power supplied from an AC power supply is converted into DC power for driving the LED elements 3a. As shown in FIG. 2, the power supply board 5 is disposed on one end (on the X1 direction side) in the lengthwise direction inside the tube 1. As shown in FIGS. 5 and 6, the power supply board 5 is electrically connected to the terminals 21 of the caps 2 via the connector cables 71a and 71b. Consequently, AC power is supplied through the terminals 21 of the caps 2 to the power supply board 5. Also, the power supply board 5 is disposed on the inside of the tube 1 at the portion covered by the cap 2. This makes the power supply board 5 less visible from the outside.

The control board 6 is configured so as to control the lighting of the LED elements 3a. More specifically, the control board 6 is configured so as to control the voltage of the DC power and supply it to the LED elements 3a. The control board 6 is also configured so as to adjust the brightness by controlling the lighting of the LED elements 3a by PWM (pulse width modulation) control. As shown in FIG. 2, the control board 6 is disposed at the other end (on the X2 direction side) in the lengthwise direction in the interior of the tube 1.

As shown in FIGS. 5 and 6, the control board 6 is electrically connected to the power supply board 5 via the connector cables 72a and 72b. That is, the power supply board 5 that is disposed at one end (the X1 direction side) in the lengthwise direction (X direction) of the heat sink 4, and the control board 6 that is disposed at the other end (the X2 direction side) in the lengthwise direction (X direction) of the heat sink 4 are connected to each other by the connector cables 72a and 72b housed in the wire housings 4a. Consequently, DC power is supplied from the power supply board 5 to the control board 6. Also, the control board 6 is electrically connected to the LED boards 3 via connector wires 61a and 61b. Consequently, power that has undergone PWM is supplied to the LED boards 3. The control board 6 is disposed on the inside of the tube 1 at the portion covered by the cap 2. This makes the control board 6 less visible from the outside.

The connector cables 7 (71a, 71b, 72a, and 72b) have a substantially circular cross sectional shape. The connector cables 7 include a conductor (not shown) and an insulator (such as vinyl chloride; not shown) that covers the outer periphery of the conductor. The insulators of the connector cables 7 are designed to be elastically deformable. This allows the connector cables 71b, 72a, and 72b to be inserted into the wire housings 4a, which have openings with the width W that is less than the diameter of the connector cables 71b, 72a, and 72b.

In this embodiment, as discussed above, the concave wire housings 4a are provided to the heat sink 4 housed in the interior of the cylindrical tube 1, at a portion of the outer face 42a that is opposite the inner face 12a of the tube 1. The connector cables 71b, 72a, and 72b, which extend from one end (the X1 direction side) to the other end (the X2 direction side) in the lengthwise direction (the X direction) of the tube 1, are housed in the concave wire housings 4a, respectively. This allows the connector cables 71b, 72a, and 72b to be housed in the concave wire housings 4a of the heat sink 4 in the interior of the cylindrical tube 1. Thus, the connector cables 71b, 72a, and 72b are not exposed on the outside. As a result, there is less damage to the connector cables 71b, 72a, and 72b. Also, housing the connector cables 71b, 72a, and 72b in the concave wire housings 4a provided to the outer face 42a of the heat sink 4 allows the connector cables 71b, 72a, and 72b to be disposed in the wire housings 4a from the outer face 42a side of the heat sink 4. Therefore, the work entailed by installing the connector cables 71b, 72a, and 72b and the work entailed by removing the connector cables 71b, 72a, and 72b can be carried out more easily than when the connector cables 71b, 72a, and 72b that extend from one end (the X1 direction side) of the tube to the other end (the X2 direction side) in the lengthwise direction (the X direction) are passed through the hollow portion of the heat sink 4 when the heat sink 4 is formed hollow.

Also, in this embodiment, as discussed above, the inner face of the cylindrical tube 1 is formed in a circular shape. The heat sink 4 is formed extending in the lengthwise direction (the X direction) of the tube 1 and having a substantially semicircular cross sectional shape. The LED boards 3 on which the LED elements 3a are mounted are disposed on the outer face of the flat face part 41. The concave wire housings 4a are formed so as to be recessed inward in the outer face 42a of the arc-shaped part 42 formed in a shape conforming to the circular inner face 42a of the tube 1. Consequently, the connector cables 71b, 72a, and 72b can be disposed in the cylindrical straight-tube LED lighting device 100 in the opposite direction (the Z2 direction) from the direction (the Z1 direction) in which the LED elements 3a emit light. Thus, the connector cables 71b, 72a, and 72b can be easily prevented from blocking the emission of light. Also, the inner face 12a of the tube 1 and the outer face 42a of the arc-shaped part of the heat sink 4 can be easily put into planar contact and the gap therebetween can be eliminated in the cylindrical straight-tube LED lighting device 100. This easily reduces tangling of the connector cables 71b, 72a, and 72b housed in the concave wire housings 4a and keeps the connector cables 71b, 72a, and 72b from coming in between the outer face 42a of the heat sink 4 and the inner face 12a of the tube 1.

Also, in this embodiment, as discussed above, the connector cables 71b, 72a, and 72b are fixed by the wire housings 4a at positions that are away from the inner face 12a of the tube 1. This prevents the connector cables 71b, 72a, and 72b from coming into contact with the inner face 12a of the tube 1 when the heat sink 4 is inserted into the tube 1 after the connector cables 71b, 72a, and 72b have been fixed in the wire housings 4a of the heat sink 4. Therefore, the connector cables 71b, 72a, and 72b are prevented from being damaged, while the work entailed during assembly of the straight-tube LED lighting device 100 is easier. Also, the connector cables 71b, 72a, and 72b are fixed in the wire housings 4a. Thus, less noise is generated by the connector cables 71b, 72a, and 72b hitting the surrounding components. Furthermore, the positions of the connector cables 71b, 72a, and 72b are fixed. Thus, the electrical characteristics can be stabilized.

Also, in this embodiment, as discussed above, the inner face of the concave wire housings 4a are formed in an arc shape that corresponds to the substantially circular outer peripheral face of the connector cables 71b, 72a, and 72b. Thus, the outer peripheral face of the connector cables 71b, 72a, and 72b and the inner peripheral face of the wire housings 4a can be fixed in a state of being in planar contact. Therefore, the connector cables 71b, 72a, and 72b can be fixed stably in the wire housings 4a.

Also, in this embodiment, as discussed above, the concave wire housings 4a are formed so that the width W of the open ends, which are the inlets for the connector cables 71b, 72a, and 72b, is less than or equal to the width of the connector cables 71b, 72a, and 72b. Thus, it is easy to keep the connector cables 71b, 72a, and 72b from coming out of the wire housings 4a.

Also, in this embodiment, as discussed above, three of the concave wire housings 4a are provided to the heat sink 4. The connector cables 71b, 72a, and 72b are housed in these three wire housings 4a. Thus, the connector cables 71b, 72a, and 72b can be housed in the wire housings 4a and protected against damage.

Also, in this embodiment, as discussed above, the connector cables 72a and 72b housed in the wire housings 4a connect the power supply board 5, which is disposed at one end (on the X1 direction side) of the heat sink 4 in the lengthwise direction (the X direction), to the control board 6, which is disposed at the other end (on the X2 direction side) of the heat sink 4 in the lengthwise direction (the X direction). Thus, the power supply board 5 and control board 6 disposed on both sides to sandwich the heat sink 4 in the lengthwise direction (the X direction) of the tube 1 can be easily connected by the connector cables 72a and 72b housed in the wire housings 4a.

The embodiment disclosed herein is just an example in every respect, and should not be interpreted as being limiting in nature. The scope of the invention being indicated by the appended claims rather than by the above description of the embodiments, all modifications within the meaning and range of equivalency of the claims are included.

For example, in the above embodiment, the LED elements 3a are used as the light emitting element. However, the present invention is not limited to this. A light emitting element other than an LED, such as a semiconductor laser element, can be used instead.

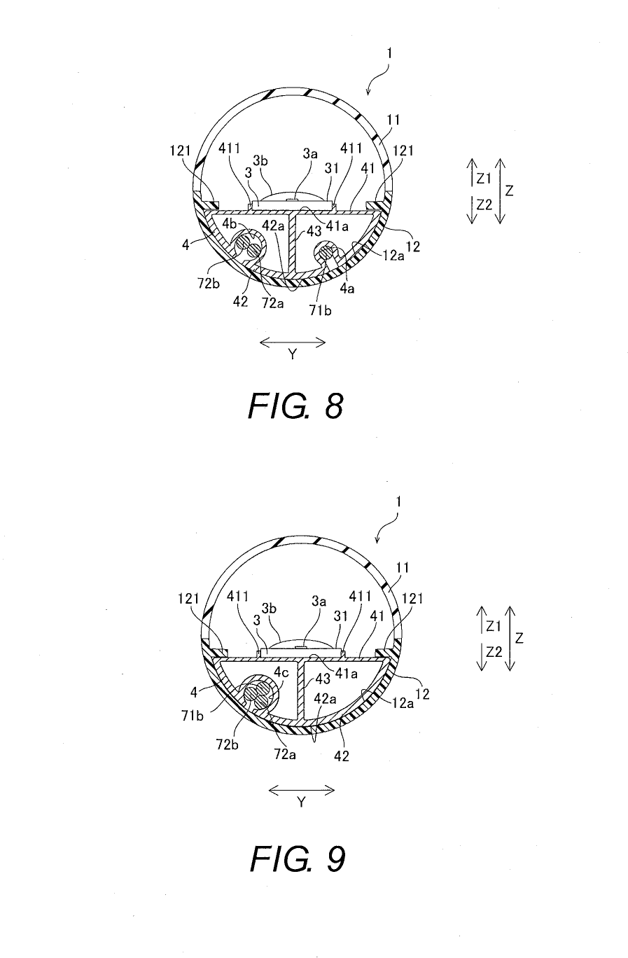

Also, in the above embodiment, the connector cables (wiring) are housed in the wire housings, respectively. However, the present invention is not limited to this. As shown in FIG. 8, two connector cables 72a and 72b can be housed in a single wire housing 4b, for example. Alternatively, as shown in FIG. 9, three connector cables 71b, 72a, and 72b can be housed in a single wire housing 4c.

Also, in the above embodiment, three connector cables (wiring) are each housed in their own wire housings, respectively. However, the present invention is not limited to this. For example, one or more wires (not just three) can be housed in wire housings, respectively.

Also, in the above embodiment, the tube has a cylindrical shape. However, the present invention is not limited to this. For example, the tube can have a shape other than cylindrical. More specifically, it can be a tube with a polyhedral shape, such as one with a rectangular (square) cross section. Furthermore, it can be a tube shaped such that the cross section has both curves and straight lines.

Also, in the above embodiment, the connector cables (wiring) have a cross section with a substantially circular shape. However, the present invention is not limited to this. For example, the wiring can have a cross section with something other than a circular shape. More specifically, the wiring can be flat wiring, such as one with an elliptical cross section. In this case, the wire housing can be formed such that its inner face has the same shape as the wiring. With this configuration, the wiring can be housed without any gaps.

The lighting device pertaining to one aspect includes a tube, a light emitting element, a heat sink, and a wire. The light emitting element is disposed inside the tube. The heat sink is disposed inside the tube. The heat sink includes a concave wire housing in an outer face of the heat sink that is opposite an inner face of the tube. The heat sink is configured to dissipate heat generated from the light emitting element. The wiring is disposed in the concave wire housing such that the wiring extends from one end of the tube to the other end of the tube in the lengthwise direction of the tube.

With the lighting device pertaining to this aspect, as mentioned above, the concave wire housing is provided to a portion of the heat sink on the outer face opposite the inner face of the tube. The wiring extends from the one end of the tube to the other end in the lengthwise direction, and is disposed in the concave wire housing. This allows the wiring to be housed in the concave wire housing of the heat sink in the interior of the tube. Therefore, the wiring is not exposed on the outside. As a result, damage to the wiring can be reduced. Also, the wiring is disposed in the concave wire housing provided to the outer face of the heat sink. This allows the wiring to be disposed in the concave wire housing from the outer face side of the heat sink. Therefore, the work entailed by installing the wiring and the work entailed by removing the wiring can be carried out more easily than when a wiring is passed through a hollow portion of a heat sink.

With the lighting device pertaining to the above aspect, the concave wire housing is located at a portion of the outer face of the heat sink that has a shape conforming or corresponding to the inner face of the tube. With this configuration, a gap between the inner face of the tube and the outer face of the heat sink can be either eliminated or reduced. This reduces tangling of the wiring housed in the concave wire housing of the heat sink and helps keep the wiring from coming in between the outer face of the heat sink and the inner face of the tube.

In this case, the inner face of the tube is formed in a circular shape. The heat sink includes the flat face part and the arc-shaped part. The heat sink extends in the lengthwise direction of the tube and has a substantially semicircular cross sectional shape. The lighting device further includes an element substrate on which the light emitting element is mounted. The element substrate is disposed on an outer face of the flat face part. The concave wire housing is recessed inward in an outer face of the arc-shaped part. The outer face of the arc-shaped part has a shape conforming or corresponding to the circular inner face of the tube. With this configuration, the wiring can be disposed in the cylindrical lighting device in the opposite direction from the direction in which the light emitting element emits light. The wiring can also be easily prevented from blocking the emission of light. Also, the inner face of the tube and the outer face of the arc-shaped part of the heat sink can be easily put into planar contact and the gap eliminated in a cylindrical lighting device. This easily reduces tangling of the wiring housed in the concave wire housing and keeps the wiring from coming in between the outer face of the heat sink and the inner face of the tube.

With the lighting device pertaining to the above aspect, the wiring is fixedly supported by the concave wire housing at a position spaced apart from the inner face of the tube. With this configuration, the heat sink is inserted into the interior of the tube after the wiring has been fixed to the wire housing of the heat sink. Thus, the wiring can be prevented from touching the inner face of the tube. Therefore, damage to the wiring can be prevented while facilitating work during assembly of the lighting device. Also, the wiring is fixed to the wire housing. Thus, less noise can be generated by the wiring hitting the surrounding parts. Also, the position of the wiring is fixed. Thus, the electrical characteristics can be stabilized.

In this case, the wiring has an outer peripheral face with a substantially circular cross sectional shape. The concave wire housing has an inner face with an arc shape corresponding to the substantially circular outer peripheral face of the wiring. With this configuration, the outer peripheral face of the wiring and the inner face of the wire housing can be fixed in a state of being in planar contact. Thus, the wiring can be fixed stably in the wire housing.

With the lighting device pertaining to the above aspect, the concave wire housing has an open end as an inlet of the wiring. The open end of the concave wire housing has a width that is less than or equal to a width of the wiring. With this configuration, it is easy to keep the wiring from coming out of the wire housing.

With the lighting device pertaining to the above aspect, a plurality of the concave wire housings (e.g., the concave wire housing and the additional concave wire housing) is provided to the heat sink. The wirings (e.g., the wire and the additional wire) are housed in these wire housings, respectively. With this configuration, a plurality of wirings can be housed in the wire housings and protected against damage.

With the lighting device pertaining to the above aspect, the lighting device further includes a first board and a second board. The first board is disposed at one end of the heat sink in the lengthwise direction of the tube. The second board is disposed at the other end of the heat sink in the lengthwise direction of the tube. The heat sink extends from the one end of the tube to the other end of the tube in the lengthwise direction of the tube. The concave wire housing extending along an entire length of the heat sink in the lengthwise direction of the tube. The wiring is housed in the wire housing. The wiring electrically connects the first board to the second board. With this configuration, the first board and second board disposed on both sides to sandwich the heat sink in the lengthwise direction of the tube can be easily connected by the wiring housed in the wire housing.

With the lighting device, the tube has a cylindrical shape. Furthermore, the tube includes a front part and a rear part. The rear part has a pair of ribs extending along an entire length of the tube in the lengthwise direction of the tube.

With the lighting device, damage to the wiring can be reduced.

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts.

While only a preferred embodiment has been chosen to illustrate the present invention, it will be apparent to those skilled in the art from this disclosure that various changes and modifications can be made herein without departing from the scope of the invention as defined in the appended claims. Furthermore, the foregoing descriptions of the embodiment according to the present invention are provided for illustration only, and not for the purpose of limiting the invention as defined by the appended claims and their equivalents.

What is claimed is:

1. A lighting device comprising:
a tube;
a light emitting element disposed inside the tube;
a heat sink disposed inside the tube, the heat sink including a concave wire housing in an outer face of the heat sink that is opposite an inner face of the tube, the heat sink being configured to dissipate heat generated from the light emitting element; and
a wiring disposed in the concave wire housing such that the wiring extends from one end of the tube to the other end of the tube in a lengthwise direction of the tube.

2. The lighting device according to claim 1, wherein
the concave wire housing is located at a portion of the outer face of the heat sink that has a shape corresponding to the inner face of the tube.

3. The lighting device according to claim 2, further comprising
an element board to which the light emitting element is mounted,
the inner face of the tube being formed in a circular shape,
the heat sink including a flat face part and an arc-shaped part, the heat sink extending in the lengthwise direction of the tube and having a substantially semicircular cross sectional shape,
the element board being disposed on an outer face of the flat face part, and
the concave wire housing being recessed inward in an outer face of the arc-shaped part, the outer face of the arc-shaped part having a shape corresponding to the inner face of the tube.

4. The lighting device according to claim 1, wherein
the wiring is fixedly supported by the concave wire housing at a position spaced apart from the inner face of the tube.

5. The lighting device according to claim 4, wherein
the wiring has an outer peripheral face with a substantially circular cross sectional shape, and
the concave wire housing has an inner face with an arc shape corresponding to the outer peripheral face of the wiring.

6. The lighting device according to claim 1, wherein
the concave wire housing has an open end as an inlet of the wiring, the open end of the concave wire housing has a width that is less than or equal to a width of the wiring.

7. The lighting device according to claim 1, further comprising
an additional wiring extending from the one end of the tube to the other end of the tube in the lengthwise direction of the tube,
the heat sink further including an additional concave wire housing in which the additional wiring is disposed.

8. The lighting device according to claim 1, further comprising
a first board disposed at one end of the heat sink in the lengthwise direction of the tube, and
a second board disposed at the other end of the heat sink in the lengthwise direction of the tube,
the heat sink extending from the one end of the tube to the other end of the tube in the lengthwise direction of the tube, the concave wire housing extending along an entire length of the heat sink in the lengthwise direction of the tube,
the wiring electrically connecting the first board to the second board.

9. The lighting device according to claim 1, wherein
the tube has a cylindrical shape.

10. The lighting device according to claim 1, wherein
the tube includes a front part and a rear part, the rear part having a pair of ribs extending along an entire length of the tube in the lengthwise direction of the tube.
